(19) United States
(12) Patent Application Publication
(10) Pub. No.: US 2016/0111226 A1
(43) Pub. Date: Apr. 21, 2016

(54) BREAKDOWN INHIBITORS FOR ELECTROCHEMICAL CELLS

(71) Applicant: REFRINGENT TECHNOLOGY LLC, Oshkosh, WI (US)

(72) Inventor: Charles P. Gibson, Oshkosh, WI (US)

(21) Appl. No.: 14/897,796

(22) PCT Filed: Jun. 17, 2014
(86) PCT No.: PCT/US14/42742

§ 371 Date: Dec. 11, 2015

Related U.S. Application Data
(60) Provisional application No. 61/836,397, filed on Jun. 18, 2013.

(51) Int. Cl. H01G 11/14; H01G 11/52; H01M 10/0567; H01G 11/56; H01G 11/58; H01M 10/42; H01G 11/84; H01G 11/54

(52) U.S. Cl. CPC H01G 11/14; H01G 11/84; H01G 11/52; H01G 11/54; H01G 11/56; H01G 11/58; H01M 10/4235; H01M 10/0567

(57) ABSTRACT

A breakdown inhibitor for electrochemical cells, which acts by trapping nucleophiles that are produced at high voltage.

### CROSS-REFERENCE TO RELATED APPLICATIONS

This application claims the benefit of U.S. Provisional Patent Application No. 61/836,397, filed on Jun. 18, 2013, the entire contents of which are incorporated herein by reference.

### FIELD

The present technology is generally related to a type of breakdown inhibitor for use in electrochemical cells that contain a liquid or gel electrolyte in contact with a solid electrode. The breakdown inhibitor is designed to scavenge reactive chemical species that form when the electrochemical cell is charged to a high voltage.

### BACKGROUND

Electrochemical cells that contain a liquid or gel electrolyte in contact with a solid electrode are commonly used to store electrochemical energy. Examples include batteries, electrochemical capacitors (which are sometimes called supercapacitors), and electrolytic capacitors. When operated at high voltage, these cells experience irreversible electrochemical reactions that cause physical damage to the cell. This degrades the performance of the cell, and, over time, may decrease capacitance, increase impedance, reduce hold time, and reduce cycle life.

Breakdown inhibitors can work by trapping chemical species that would otherwise cause damage in the cell, or by reacting to provide a physical barrier that protects cell components. For example, Fujino describes the use of an antacid that improves the performance of electrochemical capacitors by chemically reacting with (i.e., trapping) acidic groups at the positive electrode. See U.S. Pat. No. 7,457,101. Also Yang and Lucht describe an inhibitor that sacrificially reacts at high voltages and form a protective layer on the cathode of lithium ion batteries. See Yang et al. Electrochemical and Solid State Letters, 12, A229-A231 (2009).

It is difficult to design inhibitors that trap reactive breakdown products because breakdown reactions are generally complex and poorly understood. In many studies of breakdown, the aim was to determine what areas in the cell were damaged. Others were aimed at determining final chemical products of breakdown. While these studies give clues about the chemical reactions involved in breakdown, they give an incomplete picture and interpretation of the results can lead to incorrect conclusions.

An example relates to electrochemical capacitors (ECs) that use organic electrolytes. Most ECs of this type use an electrolyte based on tetraethylammonium tetrafluoroborate (TEABF4) dissolved in acetonitrile (AN). For ECs of this type, chemical analysis showed a large number of final breakdown products. See Kurzweil et al. J. Power Sources, 176, 555-567 (2008). Among the products were ethylene and other gases, and, most significantly, a polymeric deposit at the positive electrode. Possible chemical processes that account for the observed products have been suggested, but the suggestions are vague and mostly ignore the initial products formed during the electrochemical breakdown process. Studies that focused on damage showed that most damage occurred at the positive electrode, which is fouled by deposition of polymers. See Ruch, et al. Electrochimical Acta, 55, 4412-4420 (2010); Ruch, et al. Electrochimical Acta, 55, 2352-2357 (2010); Cericola, et al. J. Power Sources, 196, 3114-3118 (2011); and Zhu, et al. Carbon, 46, 1829-1840 (2008). This was attributed to cathodic polymerization of AN. See Zhu, et al. Carbon, 46, 1829-1840 (2008). Although there is no direct evidence for this explanation, it is widely accepted.

The problem with this explanation is that it contradicts prior art. For example, AN is specifically used as an electrochemically inert solvent in electrochemically-induced cationic polymerization of a variety of substrates. See Shonaike et al. Polymer Blends and Alloys, Marcel Dekker, New York (1999), page 616. In addition, there was no evidence of cationic polymerization of AN in an earlier study that explored the fundamental electrochemistry of AN-based electrolytes. See Foley et al. Can. J. Chem., 66, 201-206 (1988). Also, a survey of the synthetic organic chemistry literature does not turn up any suggestion that the AN cation is formed, even transiently, in solution.

The idea that damage to the positive electrode could originate from breakdown processes at the negative electrode is not obvious and has not heretofore been proposed. However, this could occur if, for example, the electrolyte or solvent were reduced to form a reactive nucleophile (e.g., carbanion) at the negative electrode, which then migrated to the positive electrode and caused damage. Results from the field of synthetic organic chemistry suggest that this scenario is quite plausible.

A low-energy process for the indirect reduction of AN is well known in the field of synthetic organic chemistry. See Rossi et al. Mini-Reviews in Organic Chemistry, 2, 79-90 (2005). The process, which is illustrated in FIG. 1, begins with probase dissolved in acetonitrile. As used herein, the term “probase” refers to a chemical substance that can be electrochemically reduced at a lower negative potential than the solvent, and which produces a strong Lewis base. In this example, reduction of the probase bromobenzene produces the phenyl carbanion, which is a strong Lewis base. The phenyl carbanion removes the relatively acidic proton from AN thereby producing benzene and the acetonitrile carbanion (AN⁻).

In the case of an EC, the electrodes are usually coated with activated carbon (AC). Significantly, the AC coating contains between 10¹⁹ and 10²⁰ dangling bonds (e.g., unpaired electrons in graphene sheets) per gram of carbon, which corresponds to a dangling bond concentration (mol %) of ca. 0.02 to 0.2%. See Manivannan et al. Carbon, 37, 1741-1747 (1999). As shown in FIG. 2, these dangling bonds can act as a probase. Reduction of these dangling bonds will produce carbanion sites (i.e. strong Lewis bases) in the graphene sheets, which then remove the relatively acidic proton from AN to produce AN⁻. Thus, it can be seen that there exists a plausible low-energy mechanism for producing AN⁻ at the negative electrode of ECs.

FIG. 3 shows a process whereby AN⁻, which may be formed at negative electrode, can produce a polymer residue on the positive electrode. In this process, AN⁻ formed at the negative electrode migrates through the separator and accumulates near the positive electrode. Next, a one-electron reduction at the positive electrode reduces AN⁻ to the acetonitrile radical. Organic radicals are, in general, very effective polymerization catalysts. The acetonitrile radical at the positive electrode then catalyzes polymerization at the positive electrode, which accounts for the deposition of the polymeric film that fouls the positive electrode. The production of AN⁻ at the negative electrode also explains the production of ethylene during cell breakdown as shown in FIG. 4.

Although not wishing to be bound by the particulars of any theory, the preceding discussion shows how the production of a nucleophile (e.g. AN⁻) at the negative electrode explains the observed damage at the positive electrode, and how it explains the observed production of ethylene. This suggests a new type of breakdown inhibitor for this type of electrochemical cell. Specifically, substances that react with (i.e., trap) the nucleophile produced at the negative electrode (e.g., AN⁻) can be included in the cell, where they would improve performance by inhibiting key breakdown reactions.

Methods for trapping nucleophiles are well known. For example, nucleophiles can be trapped with inorganic substrates (e.g., cuprates), with p-type semiconductors, ceramics with positively charged surface sites, or with organic substrates (e.g., ketones). The reactions of a nucleophile with these substances are illustrated in FIGS. 5-10. In a general sense, this invention relates to a breakdown inhibitor that is designed to trap a nucleophile that is formed at the negative electrode, thereby preventing breakdown.

### SUMMARY

In one aspect, an electrochemical cell provided including a breakdown inhibitor, wherein the breakdown inhibitor is configured to react with a nucleophile, and the electrochemical cell exhibits improved performance when compared to a cell without the breakdown inhibitor. In some embodiments, the breakdown inhibitor is an inorganic compound. In some embodiments, the inorganic compound includes copper. In any of the above embodiments, the inorganic compound includes a copper ion and an anion comprising F⁻, Cl⁻, Br⁻, O²⁻, CN⁻, or NCO⁻. In any of the above embodiments, the inorganic compound includes copper chloride, copper bromide, copper cyanide, calcium copper titanate, or calcium (strontium) copper titanate.

In any of the above embodiments, the breakdown inhibitor includes an organic substrate that contains an aldehyde or ketone functional group that is configured to react with a nucleophile via a 1,2-addition reaction. In some embodiments, the breakdown inhibitor is an organic substrate that contains both a carbonyl moiety and a conjugated chain wherein nucleophilic attack of the conjugated chain leads results in conversion of the double bond in the carbonyl moiety to a single bond. In some embodiments, the breakdown inhibitor includes an enone moiety that can react with nucleophile via a 1,4-addition. As used herein an eneone has the following structure: —C(O)CR═CR′—, where R and R′ are individually H, alkyl or aryl. In some embodiments, R and R′ are H, C₁-C₁₀ alkyl, or C₆-C₁₂ aryl.

In some embodiments, the breakdown inhibitor is a substance having a pKₐ that is lower than the pKₐ of the nucleophile, and the breakdown inhibitor is configured to be deprotonated by the nucleophile. In any of the above embodiments, the breakdown inhibitor may exhibit a pKₐ from about 10 to about 25, inclusive. In some embodiments, the breakdown inhibitor includes particles having a positively charged surface moiety.

In some embodiments, the breakdown inhibitor includes a semiconductor configured to react with a nucleophilic product of electrolyte breakdown.

In any of the above embodiments, the electrode, anode, cathode, electrolyte, packaging or separator may include the breakdown inhibitor.

In any of the above embodiments, the improved performance is exhibited as an increased operating voltage, an increased cycle life, an increased operating temperature, an increased voltage window, an increased hold time, a decreased leakage current, a decreased impedance rise, or decreased corrosion.

In any of the above embodiments, the electrochemical cell may be an electrochemical capacitor, an electrolytic capacitor, a battery, or an electrolytic cell. In any of the above embodiments, the electrochemical cell also includes a non-aqueous electrolyte. In such embodiments, the non-aqueous electrolyte may include a solvent of propylene carbonate, ethylene carbonate, butylene carbonate, gamma-butyrolactone, gamma-valerolactone, acetonitrile, propionitrile, glutaronitrile, adiponitrile, methoxyacetonitrile, N,N-dimethylformamide, N,N-dimethylacetamide, N-methylpyrrolidone, N-methyloxazolidione, nitromethane, nitroethane, sulfolane, 3-methylsulfolane, dimethyl-sulfoxide, or trimethylphosphate. In some embodiments, the electrochemical cell is an electrochemical capacitor, and the non-aqueous electrolyte includes acetonitrile, propionitrile, glutaronitrile, adiponitrile, methoxyacetonitrile, ethylene carbonate, or propylene carbonate.

In another aspect, a component of an electrochemical cell that contains a breakdown inhibitor is provided, and which is configured to trap nucleophiles thereby improving cell performance. As used herein, “trap” means to convert a chemical product of breakdown reactions that is capable of causing damage to the cell into a substance that causes less damage. As used herein, “improving cell performance” means that cells containing the component with the breakdown inhibitor show better performance than similar cells with a similar component lacking the inhibitor. Examples of better performance may include one or more of the following: higher operating voltage, lower capacitance fade, lower leakage current, longer cycle life, longer service life, lower impedance rise, or longer hold time. In one embodiment, the component is an electrode. In another embodiment, the component is an electrolyte. In another embodiment, the component is a separator. In any of the above embodiments, the component comprises an element of the cell packaging. In one embodiment, the component is a separator, and the breakdown inhibitor is chemically bound to the separator. In another embodiment, the component is a separator, and the breakdown inhibitor is an active chemical site on the surface of a solid phase that is incorporated in the separator. In one embodiment, the component is an electrode coating, and the breakdown inhibitor is chemically bound to the electrode coating. In another embodiment, the component is an electrode coating, and the breakdown inhibitor is an active chemical site on the surface of a solid phase that is incorporated in the electrode coating.

In another aspect, an electrochemical cell is provided that contains a component with a breakdown inhibitor that is configured to trap nucleophiles and improve cell performance. In any of the above embodiments, the electrochemical cell is a battery. In any of the above embodiments, the electrochemical cell is a lithium-ion battery including an organic carbonate or ether. In any of the above embodiments, the electrochemical cell is an electrochemical capacitor (EC). As used herein, the term “electrochemical capacitor” and the abbreviation “EC” refer to any device wherein charge at least one electrode is stored in one of the following ways: via double layer formation, via pseudocapacitance, or via a combination of double layer formation and pseudocapacitance. In any of the above embodiments, the electrochemical cell is an EC including an organic nitrile or an organic carbonate. In any of the above embodiments, the EC includes acetonitrile.

In another aspect, a method is provided for producing an electrochemical cell. The method includes providing a multilayer structure including a cathode and an anode separated by a distance; providing an electrolyte between the first and second electrodes, wherein the electrolyte contacts the surfaces of the first and second electrodes; providing a packaging element to contain the multilayer structure and electrolyte; providing a breakdown inhibitor, which is incorporated into at least one of the layers of the multilayer structure, the electrolyte, or the packaging element; and subjecting the electrochemical cell to an electric potential that is sufficient to produce breakdown reactions in a control. As used herein, the term “control” means an electrochemical cell that does not contain a breakdown inhibitor but which is otherwise identical to an electrochemical cell that does contain a breakdown inhibitor. In the method, the providing a multilayer structure may also include providing a separator disposed between the cathode and the anode. In any of the methods, the separator, anode, cathode, or electrolyte may include the breakdown inhibitor.

The specifications given above serve to illustrate the usefulness of the present technology and are not intended to limit its scope in any manner. Those with ordinary knowledge in the field will recognize that features described in the specifications can be combined and that the result will still fall within the scope of this invention, and that specific materials described in the examples can be substituted with other materials that provide similar functionality.

### BRIEF DESCRIPTION OF THE DRAWINGS

FIG. 1 is a descriptive illustration of indirect reduction of AN, wherein a probase is converted to a base, which then deprotonates the AN to form the AN⁻ carbanion.

FIG. 2 is a descriptive illustration showing the indirect reduction of AN at the activated carbon coated negative electrode of an electrochemical capacitor.

FIG. 3 is a descriptive illustration showing the indirect reduction of AN at the negative electrode, the migration of the AN⁻ carbanion to the positive electrode, oxidation of the AN⁻ carbanion to form the corresponding radical, and free radical induced polymerization that degrades the positive electrode.

FIG. 4 is a descriptive illustration showing how ethylene can be produced by reaction of the AN⁻ carbanion with the tetraethylammonium cation.

FIG. 5 is an illustration of a reaction of a carbanion with a cuprous cyanide to form the corresponding cuprate, according to the examples.

FIG. 6 illustrates how a carbanion may be trapped by a p-type semiconductor, according to the examples.

FIG. 7 illustrates how a carbanion may be trapped by a ceramic that contains positively charged sites at the surface, according to the examples.

FIG. 8 illustrates how a carbanion may be trapped by 1,2-addition to a ketone, according to the examples.

FIG. 9 illustrates how a carbanion may be trapped by 1,4-addition to an enone, according to the examples.

FIG. 10 illustrates how a carbanion may abstract a proton from a substrate molecule to form a less reactive nucleophile, according to the examples.

FIG. 11 illustrates a separator that contains a cuprous moiety bound to an insoluble ceramic component, according to the examples.

FIG. 12 illustrates a separator that contains an organic moiety bound to an insoluble polymeric support. In this case, the organic moiety is a ketone that can undergo 1,2 addition, according to the examples.

FIG. 13 is a scanning electron micrograph showing a cross-sectional view of a separator, as described in Example 8, according to the examples.

FIG. 14 is a cyclic voltammogram showing the larger voltage window of an EC containing the separator of Example 8 as compared to the smaller voltage window of a control, according to the examples.

FIG. 15 shows that lower capacitance fade of a device containing the separator of Example 8 as compared to the higher voltage fade of a control, according to the examples.

FIG. 16 shows that lower impedance rise of a device containing the separator of Example 8 as compared to the higher voltage fade of a control, according to the examples.

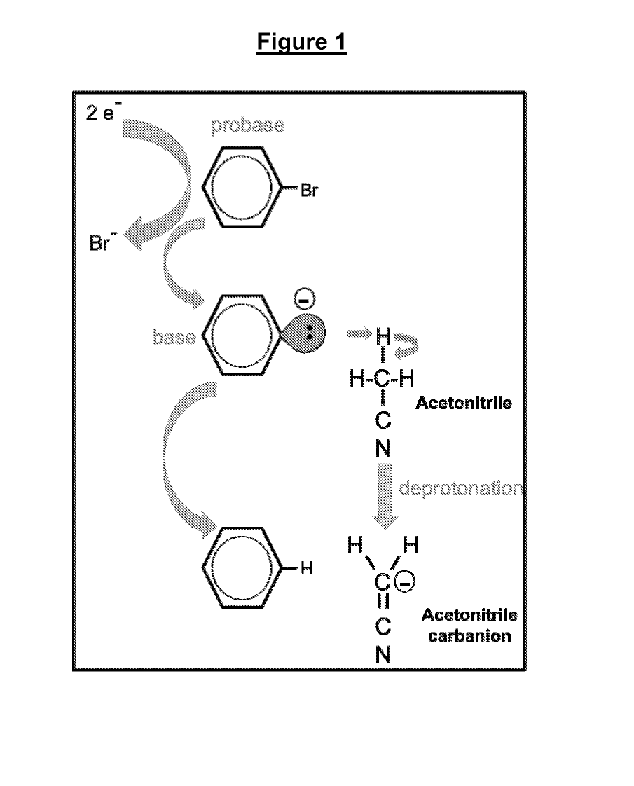

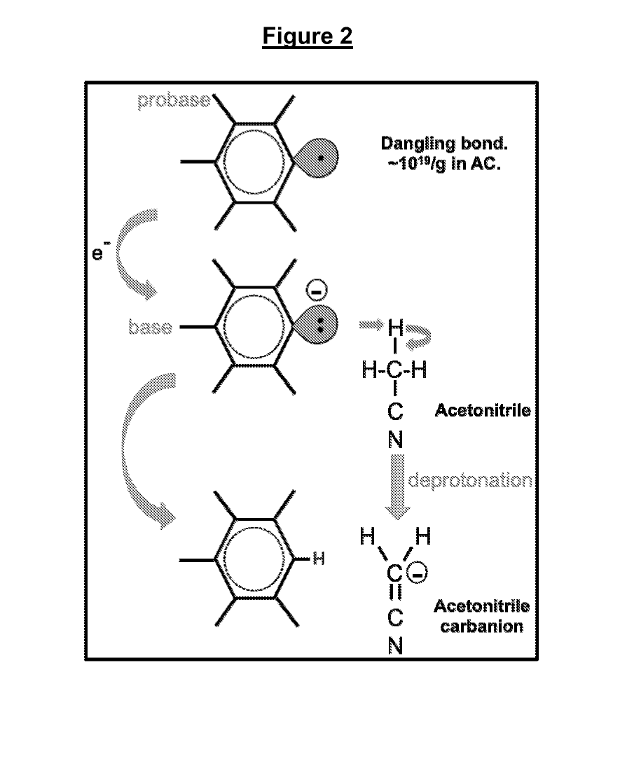

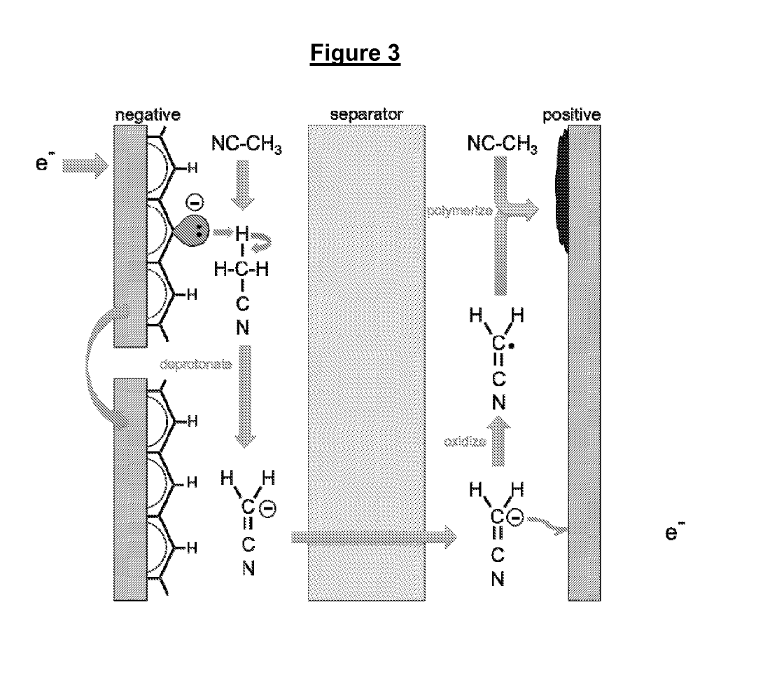

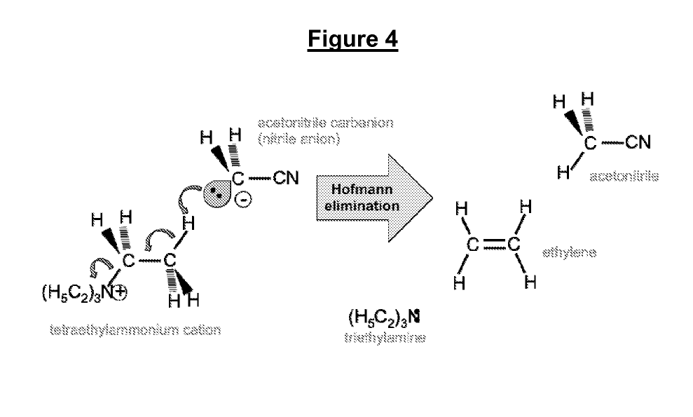

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand process of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the terms “cell” and “electrochemical cell” refer to devices that store energy via charge separation and devices that store charge via faradaic processes, where the device contains at least two solid electrodes and a liquid. An electrochemical capacitor is an example of the former, and a battery is an example of the latter. A wide variety of cell types, materials, device architectures, and packaging may be used in the construction of the various cells.

As used herein, the term “breakdown reactions” refers to the irreversible electrochemical reactions that occur at high voltage and cause, either directly or indirectly, cell damage; the term “high voltage” refers to a voltage above which breakdown reactions occur; the term “breakdown” refers to damage to the cell caused by breakdown reactions, and the term “breakdown inhibitor” refers to a chemical compound that improves cell performance by inhibiting breakdown.

As used herein, the term “improved performance” means that an electrochemical cell with a breakdown inhibitor is more useful than an equivalent cell without an inhibitor because its electrochemical properties are better suited for the desired application. Those with ordinary knowledge in the field understand that exact nature of the improved performance depends on the particular application for the cell and further understand that there are numerous ways to measure or quantify the improved performance. Illustrative examples of improved performance and ways to quantify the improvement include, but are not limited to, increased cycle-life, operating voltage, operating temperature, operating voltage window, and hold time, or decreased leakage current, impedance rise, and corrosion.

As used herein, the term “cycle-life” refers to the number of charge/discharge cycles a device can tolerate before performance drops below a specified level. This is generally determined by subjecting the cell to repeated charge/discharge cycles between a certain lower voltage and a certain higher voltage, where the term “lower voltage” means the voltage limit closest to the open circuit voltage of the fully discharged device, and “higher voltage” means the voltage limit farthest from the open circuit voltage of the fully discharged device. The lower and higher voltage limits are most commonly the nominal operating limits specified for the device, the charge/discharge cycles are conducted at a constant current, and testing is conducted at a specified constant temperature. The process is continued until a specified performance metric exceeds a certain specified limit. For electrochemical capacitors, for example, that limit is frequently specified to be a 20% drop in capacitance compared to the original capacitance of the cell, or else a 100% increase in DC impedance compared to the original cell. A higher cycle life is desirable, and a meaningful increase is about 5% or more.

The operating voltage of a device may be determined specifying a minimum acceptable cycle-life for the device and then conducting a series of cycle life experiments at different higher voltage limits. The experiments will show that cycle-life decreases with as the higher voltage limit is increased. The operating voltage is revealed by the test having maximum value of the higher voltage limit and having a cycle life that meets specification. Increased operating voltage means that a test cell (e.g., cell with inhibitor) has a higher operating voltage than a control cell (e.g., cell without inhibitor). In some embodiments, an increased operating voltage may be about 5%, or greater, than a compared device.

The operating temperature of a device may be determined by cycle-life testing. First, baseline cycle-life tests are conducted with a control cell (e.g., cell without inhibitor) and a test cell (e.g., cell with inhibitor). Next, a cycle-life test is conducted on new test cell (which is identical to the original) at a temperature that is higher than the temperature used for baseline testing. This is repeated until the cycle-life of the test cell falls below the cycle-life measured for the original control cell in the baseline test. The operating temperature for the test cell is determined based on the highest temperature test that gives a cycle-life that is at least as high as that of the control measured in the baseline test. In some embodiments, an increased operating temperature may be about 5° C., or greater, than a compared device.

As used herein, the term “voltage window” refers the voltage range (i.e., lower and upper voltage limits) that can be tolerated without breakdown. This can be determined via a series of cyclic voltammetry (CV) scans wherein the higher voltage of successive scans is incrementally increased. Breakdown, when it occurs, is revealed as an exponential increase in current as voltage is increased above the threshold potential for breakdown. This behavior will be observed only in CV scans where the higher voltage limit is above this threshold. The voltage window is determined from the CV scan that has the highest value for the higher voltage limit and which lacks the exponential increase of current with increasing voltage. The voltage window is taken to be the lower and higher voltage limits of this CV scan. In general, a larger voltage window is desirable, and an increased voltage window means that a test cell (e.g., cell with inhibitor) has a larger voltage window than a control cell (e.g., cell without inhibitor). In some embodiments, an increased voltage window may be about 5%, or greater, than a compared device.

In general, hold time refers to the amount of time required for the open circuit voltage of a fully charged device to fall below some specified value. For electrochemical capacitors, the specified value is commonly taken to be 80% of the voltage of the fully charged device. Increased hold time means that a test cell (e.g., cell with inhibitor) has a longer hold time than a control (e.g., cell without inhibitor). In some embodiments, an increased hold time may be about 5%, or greater, than a compared device.

As used herein, the term “leakage” refers to the small current required to keep a fully charged cell in its fully charged state. Decreased leakage current means that a test cell (e.g., cell with inhibitor) has a lower leakage current than a control cell (e.g., cell without inhibitor). In some embodiments, the hold time may be decreased by about 5%, or more, than a compared device.

As used herein, the term “impedance rise” refers to the impedance of a cell increasing as the cell is subjected to a series of charge/discharge cycles. Decreased impedance rise means that the impedance rise in a test cell (e.g., cell with inhibitor) is less than impedance rise of a control cell (e.g., cell without inhibitor). In some embodiments, impedance rise is decreased by about 5%, or more, than a compared device.

As used herein, the term “corrosion” refers to physical damage of cell components caused by undesirable electrochemical reactions that occur during operation. Corrosion is generally revealed by first operating the cell, and then disassembling the cell and examining components for visual or microscopic signs of physical damage. Decreased corrosion means that a test cell (e.g., cell with inhibitor) exhibits less corrosion than a control cell (e.g., cell without inhibitor).

As used herein, the term “liquid electrolyte” refers to an electrolyte having rheological properties that typify a liquid, gel, or melt at the operating temperature of the device.

As used herein, the term “solid electrode” refers to any electrode that forms a distinct phase boundary between the electrode and the electrolyte. While most electrodes of this type are true solids (i.e., have a defined rest state), certain gel and even liquid electrodes (e.g., mercury electrodes) conform to this specification and are herein included as members of the class of solid electrodes as a matter of convenience.

As used herein, the term “negative electrode” refers to the electrode that has the more negative potential in an electrochemical cell when the cell is being charged. Under these conditions, electrochemical reduction (cathodic reactions) is favored at the negative electrode. The term “positive electrode” refers to the electrode that has the more positive potential in an electrochemical cell when the cell is being charged. Under these conditions, electrochemical oxidation (anodic reactions) is favored at the positive electrode.

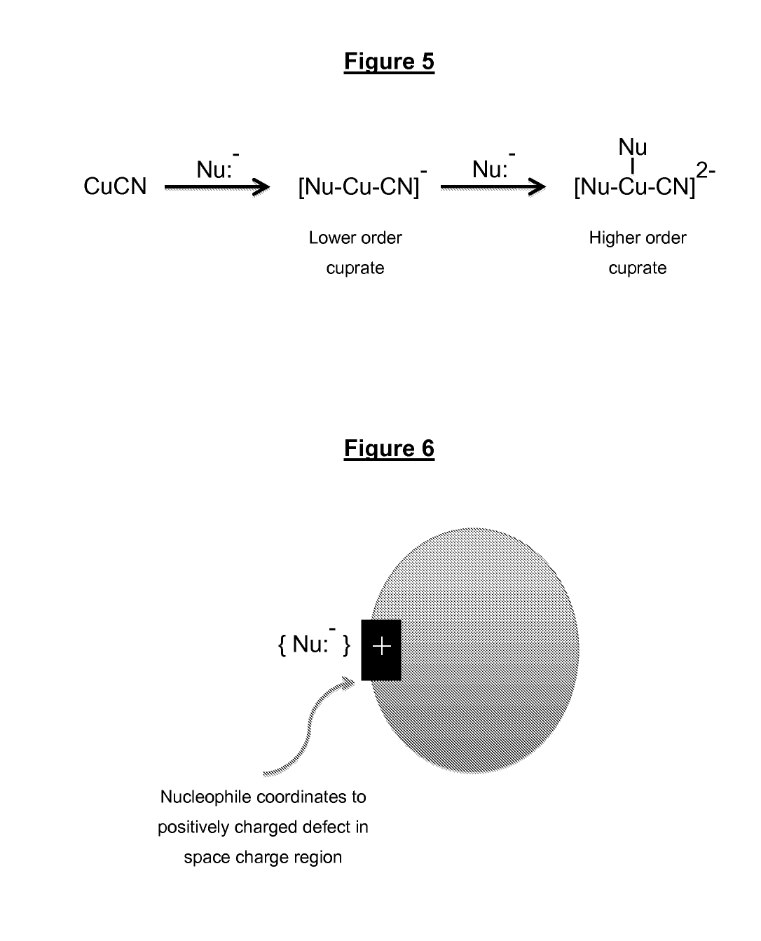

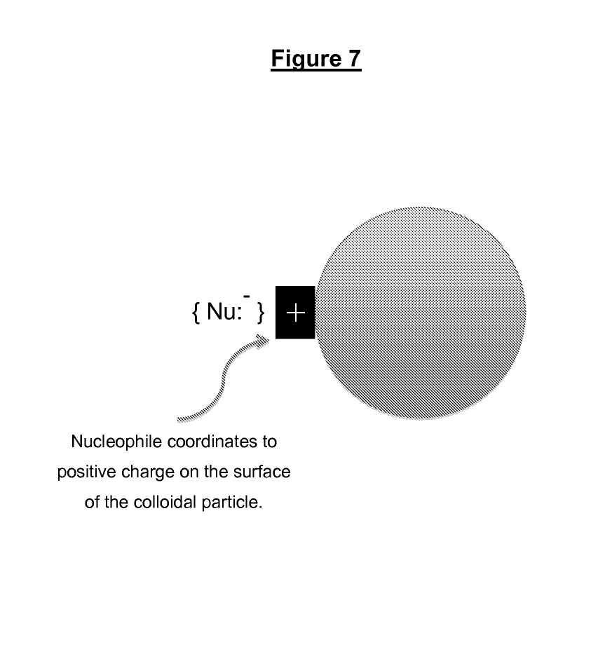

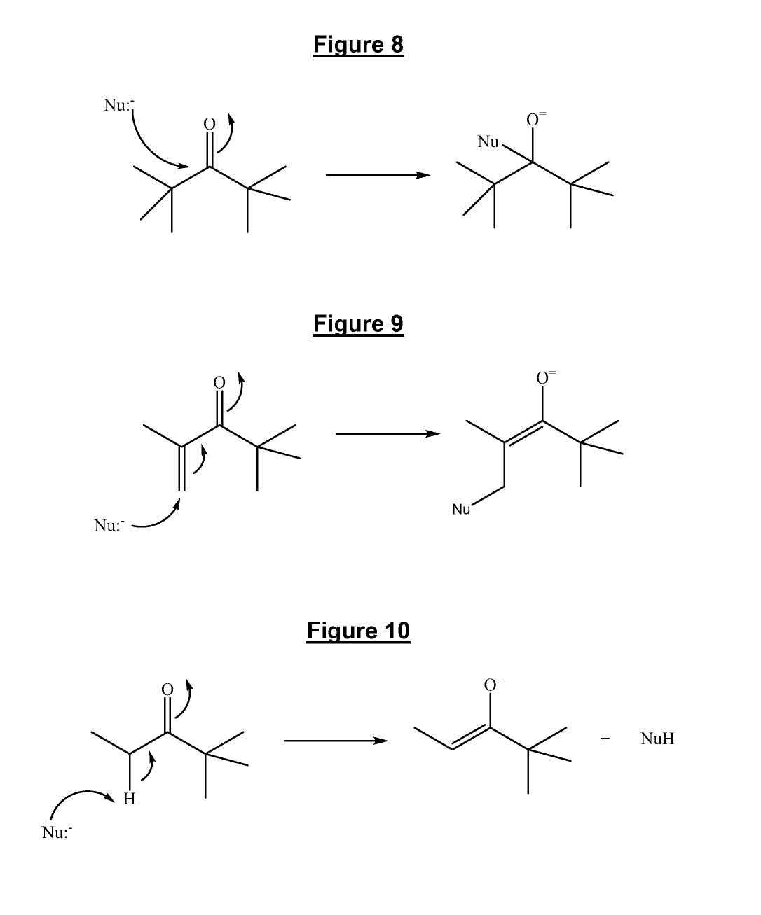

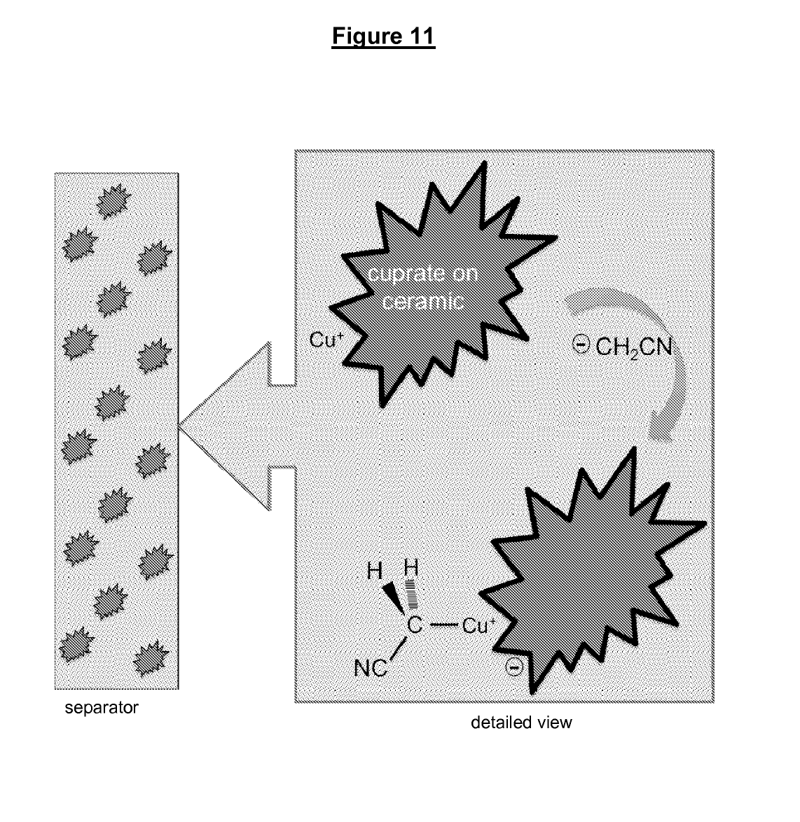

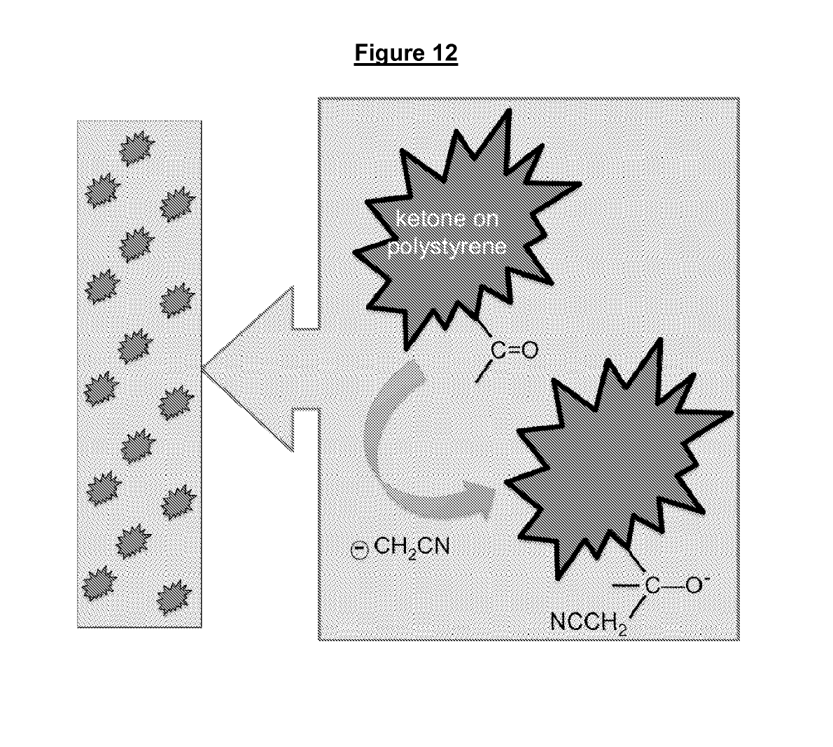

The present technology is generally related to breakdown inhibitors that are capable of trapping nucleophiles that are formed at the negative electrode, wherein the breakdown inhibitor is used in the construction of a cell. Referring now to FIG. 5, the breakdown inhibitor may be an inorganic substance that traps nucleophiles. In this case, the inorganic substance is a cuprous salt, which reacts with the nucleophile to form a cuprate. Referring now to FIG. 6, the breakdown inhibitor may be a semiconductor. In this case, the nucleophile is trapped at electron deficient sites (e.g. electron holes, p-type impurities, etc.) on the surface. Referring now to FIG. 7, the breakdown inhibitor may be a ceramic particle that traps nucleophiles at positively charged sites at the particle surface. Referring now to FIGS. 8 and 9, the breakdown inhibitor may be an organic substrate that is susceptible to nucleophilic attack. Suitable organic substrates include compounds that contain a one or more carbon-carbon or carbon-heteroatom multiple bonds, wherein attack of the nucleophile occurs at the multiple bond. In some cases, nucleophilic attack in such compounds results in formation of an anion at an atom adjacent to the site of nucleophilic attack, which is herein referred to as 1,2 addition. This is illustrated in FIG. 8. In other cases, nucleophilic attack in such compounds results in formation of an anion at an atom that is farther away from the site of nucleophilic attack. Examples in which the anion forms on atom separated by three bonds from the original site of attack are common. This is herein referred to as 1,4 addition, and is illustrated in FIG. 9. Referring now to FIG. 10, the breakdown inhibitor may be a molecule that has a proton that can be abstracted by reaction with the nucleophile. In this case, the nucleophile formed at the anode reacts with the inhibitor to form a second nucleophile, and it is this second nucleophile that is trapped.

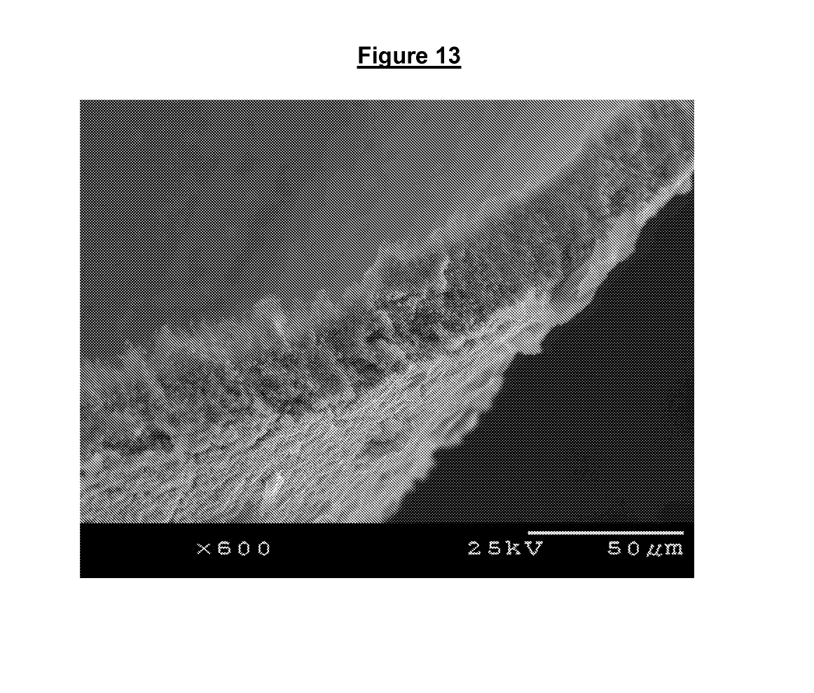

In one aspect, the breakdown inhibitor is included in an electrochemical cell. In one embodiment, the breakdown inhibitor is contained in an electrode. In another embodiment, the breakdown inhibitor is coated onto an electrode. In another embodiment, the breakdown inhibitor is contained in the separator. In one embodiment, the breakdown inhibitor is bound to an insoluble component in the separator. FIG. 11 illustrates a separator containing a cuprous moiety bound to an insoluble ceramic, and FIG. 12 illustrates a separator containing an organic trap bound to an insoluble organic substrate (e.g., cross linked polystyrene.)

The present invention, thus generally described, will be understood more readily by reference to the following examples, which are provided by way of illustration and are not intended to be limiting of the present invention.

### EXAMPLES

### Example 1

Cuprous salts.

Sufficient cuprous cyanide is added to a 1M TEABF₄/AN (TEAFB₄ is tetraethylammonium tetrafluoroborate) electrolyte to provide a mixture that is about 1 mM in copper. As illustrated in FIG. 5, the copper cyanide reacts with nucleophiles that form at the negative electrode and trapping said nucleophiles in the form of less reactive cuprate complexes.

### Example 2

1,2-addition to an organic electrophile.

Sufficient 2,2,4,4-tetramethyl-3-pentanone is added to a 1M TEABF₄/AN electrolyte to provide a solution that is 1 mM in the ketone. As illustrated in FIG. 8, the ketone reacts with nucleophiles that are produced at the negative electrode via 1,2 addition, and trapping them as less reactive alkoxides.

### Example 3

1,4-addition to an organic electrophile.

Sufficient 4-ethyl-2,2,5-trimethyl-4-hexen-3-one is added to a 1M TEABF₄/AN electrolyte to provide a solution that is 1 mM in the enone. As illustrated in FIG. 9, the enone reacts with nucleophiles that are produced at the negative electrode via 1,4-addition, and trapping them as less reactive alkoxides.

### Example 4

Deprotonation an organic substrate.

Sufficient 3-pentanone is added to a 1M TEABF₄/AN electrolyte to provide a solution that is 1 mM in the ketone. The ketone is capable acting as a Lewis acid with respect to nucleophiles that are also strong Lewis bases. As a result, the nucleophile produced at the negative electrode is neutralized, and the ketone is converted to a nucleophile that is less reactive than the nucleophile that was produced at the negative electrode. This is illustrated in FIG. 10.

### Example 5

Separator with bound cuprous ion.

A jar is charged with: 0.25 g cuprous cyanide, 5 g of −325 mesh silica beads, 10.0 mL of N-methylpyrrolidone (NMP), and 17.5 g of a solution including 12.5% (w/w) polyvinylidenedifluoride (PVdF) dissolved in NMP. Zirconia grinding media is added and then the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. The resulting film contains cuprous cyanide dispersed in a ceramic/polymer matrix. The cuprous ion reacts with nucleophiles and traps them as a cuprate complex.

### Example 6

Separator with bound organic substrate molecules.

A highly cross-linked functionalized polystyrene resin, such as sold by Novabiochem, is treated with a desired organic substrate molecule so as to form a chemical bind between the resin and the substrate. The organic substrate may be a molecule capable of 1,2-addition (as in Example 2), 1,4-addition (as in Example 3), deprotonation (as in example 4), or other reaction with nucleophiles formed at the negative electrode. 10 grams of the treated resin is combined with 10.0 mL of N-methylpyrrolidone (NMP), and 17.5 g of a solution including 12.5% (w/w) polyvinylidenedifluoride (PVdF) dissolved in NMP. Zirconia grinding media is added and then the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous polymer film. The polymer film is then lifted off the glass and dried in a vacuum chamber. The resulting film contains organic moieties that are capable of trapping nucleophiles

### Example 7

Separator with ceramic trap.

Silica particles with positively charged surface sites are first synthesized by a conventional sol-gel process in the presence of a polyelectrolyte. The product is isolated and screened to −325 mesh. A jar is charged with: 5 g of −325 mesh silica, 10.0 mL of N-methylpyrrolidone (NMP), and 17.5 g of a solution including 12.5% (w/w) polyvinylidenedifluoride (PVdF) dissolved in NMP. Zirconia grinding media is added and then the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. The nucleophiles that are produced at the negative electrode are trapped at the positively charged sites on the surface of the silica.

### Example 8

Fabrication of a ceramic/polymer composite separator.

A jar is charged with: 7.50 g of calcium copper titanate (CCTO), 10.0 mL of N-methylpyrrolidone (NMP), and 17.5 g of a solution including 12.5% (w/w) polyvinylidenedifluoride (PVdF) dissolved in NMP. Zirconia grinding media is added and the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. As illustrated in FIG. 5, the CCTO is believed to trap the nucleophile produced at the negative electrode as a less reactive cuprate. FIG. 13 is a scanning electron microscopy image showing a cross sectional view of a separator of Example 8.

### Example 9

Fabrication of a ceramic/polymer composite separator.

A p-type large band-gap semiconductor is produced by reacting barium carbonate, titania, and a small amount of lanthanum carbonate at high temperature. A jar is charged with: 7.50 g of the lanthanum-doped barium titanate (BLTO), 10.0 mL of N-methylpyrrolidone (NMP), and 17.5 g of a solution including 12.5% (w/w) polyvinylidenedifluoride (PVdF) dissolved in NMP. Zirconia grinding media is added and then the jar is sealed and placed on a jar mill where the mixture is milled for one hour. The suspension is decanted from the jar and spread onto a glass plate using a doctor blade with a 350 μm gap. The coated glass plate is then placed in a curing chamber where the solvent is evaporated to leave behind a thin porous ceramic/polymer film. The ceramic/polymer film is then lifted off the glass and dried in a vacuum chamber. The BLTO is believed to trap the nucleophile produced at the negative electrode at p-type defects at the surface.

### Example 10

Fabrication of an EC.

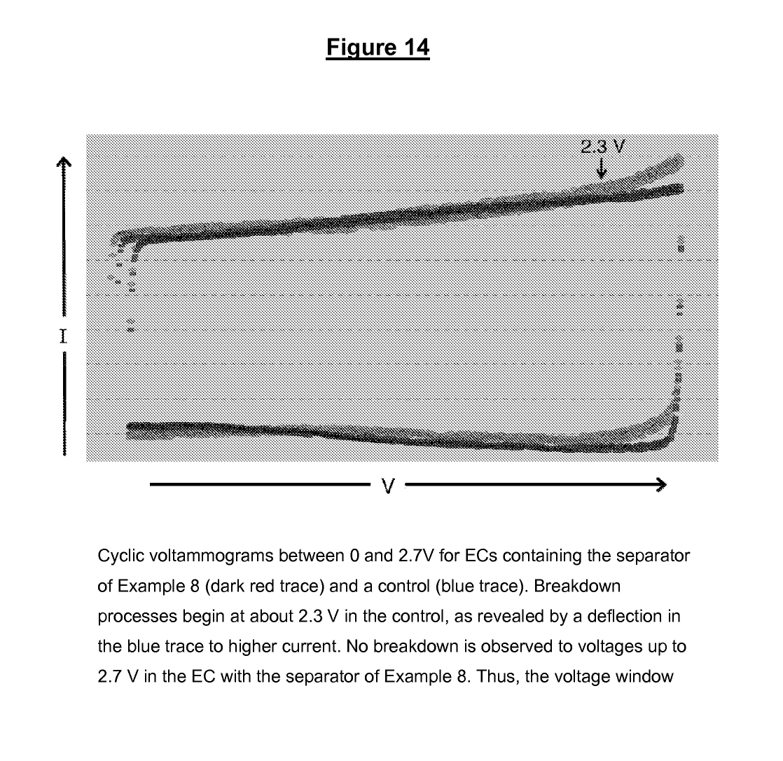

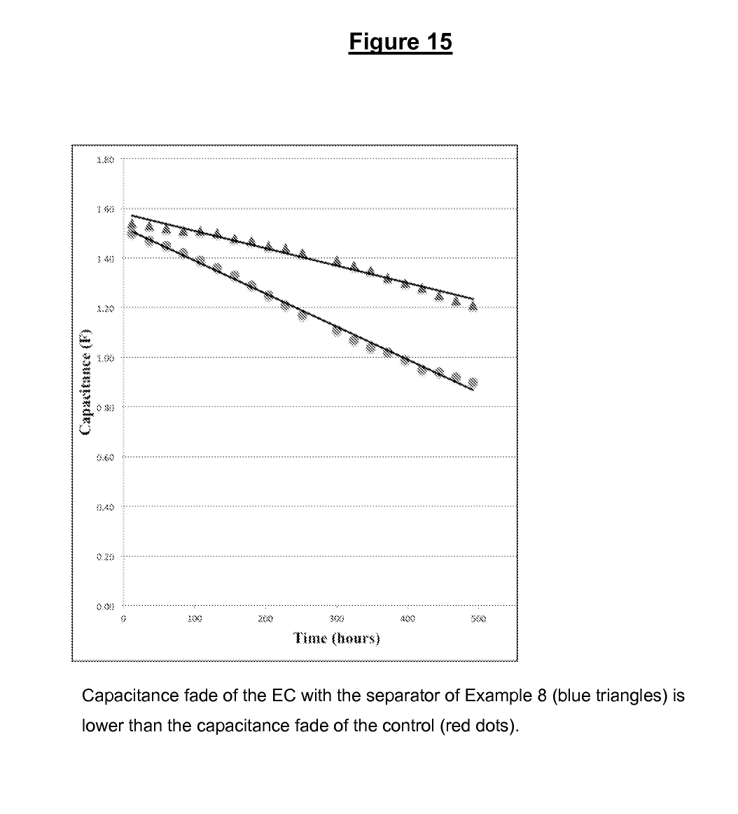

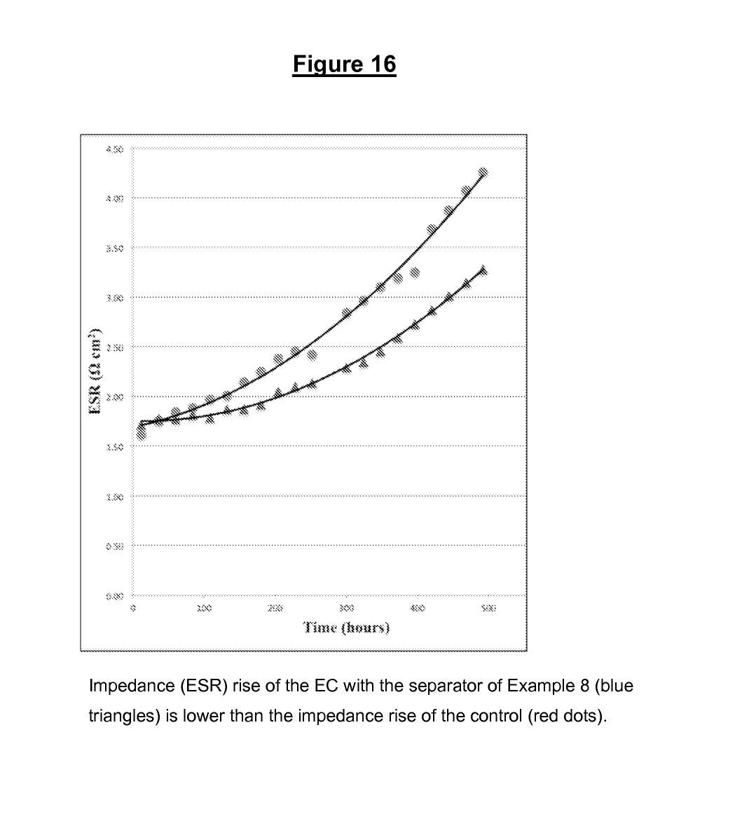

Components of the cell include: (1) electrodes based on an etched aluminum current collector coated with a film that includes activated carbon as the main ingredient, carbon black as a minor ingredient, and a minor amount of polytetrafluoroethylene (PTFE) binder; (2) 1M TEABF₄/AN electrolyte; and (3) a separator as described in any of the examples 5-9. The electrodes were cut into 19 mm disks, and the separators were cut into 25 mm disks. The components were packaged in flat cell containers including aluminum structural elements (i.e., an aluminum case) with PTFE seals. ECs made by this process typically had capacitance between 0.8 and 1.6 F depending on the thickness of the coating of the electrodes. For comparison, cells that contained conventional paper separators but were otherwise identical were fabricated. These served as controls. Electrochemical testing showed that the ECs containing the separator with breakdown inhibitor showed better performance than the control ECs. FIGS. 14-16 show some results of testing an EC containing a separator as described in Example 8 versus a control. FIG. 14 shows that the electrochemical window is larger for the EC with the separator of Example 8. FIG. 15 shows that the capacitance fade is lower for the EC with the separator of Example 8. FIG. 16 shows that the impedance rise is lower for the EC with the separator of Example 8.

### Example 11

Postmortem examination of ECs.

Two ECs were constructed as described in Example 10, except that stainless-steel flat cell containers were used. The cells were charged to high voltage (3.3 V). Afterwards, the cells were disassembled and examined for evidence of damage. In the case of the EC with the paper separator, a significant amount of brown residue, an electrolyte decomposition product, was observed. In contrast, there was very little brown residue in the EC that had contained the separator with the breakdown inhibitor. Also, the cell that had contained the paper separator showed more corrosion on the current collector of the positive electrode, whereas very little corrosion was observed in the case of the EDLC that had contained the separator with the breakdown inhibitor. These observations confirm that separator that contained the breakdown inhibitor protected the EC against damage caused by breakdown reactions.

While certain embodiments have been illustrated and described, it should be understood that changes and modifications can be made therein in accordance with ordinary skill in the art without departing from the technology in its broader aspects as defined in the claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent processes and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. An electrochemical cell comprising a breakdown inhibitor, wherein the breakdown inhibitor is configured to trap a nucleophile, and the electrochemical cell exhibits improved performance when compared to a cell without the breakdown inhibitor.

2. The electrochemical cell of claim 1, wherein the breakdown inhibitor is an inorganic compound.

3. The electrochemical cell of claim 2 wherein the inorganic compound comprises copper.

4. The electrochemical cell of claim 2, wherein the inorganic compound comprises a copper ion and an anion comprising F⁻, Cl⁻, Br⁻, O²⁻, CN⁻, or NCO⁻.

5. The electrochemical cell of claim 2, wherein the inorganic compound comprises copper chloride, copper bromide, copper cyanide, calcium copper titanate, or calcium (strontium) copper titanate.

6. The electrochemical cell of claim 1, wherein the breakdown inhibitor comprises an organic substrate having an aldehyde or ketone functional group that is configured to react with a nucleophile via a 1,2-addition reaction.

7. The electrochemical cell of claim 1, the breakdown inhibitor is an organic substrate that contains both a carbonyl moiety and a conjugated alkyl or aryl moiety.

8. The electrochemical cell of claim 1, wherein the breakdown inhibitor is an organic substrate configured to react with a nucleophile via a 1,4-addition reaction.

9. The electrochemical cell of claim 8, wherein the breakdown inhibitor comprises an enone moiety.

10. The electrochemical cell of claim 9, wherein the enone moiety is a compound of formula —C(O)CR═R′—, wherein R and R′ are individually H, alkyl, or aryl.

11. The electrochemical cell of claim 1, wherein the breakdown inhibitor exhibits a pKₐ that is lower than the pKₐ of the nucleophile, and the breakdown inhibitor is configured to be deprotonated by the nucleophile.

12. (canceled)

13. The electrochemical cell of claim 1, wherein the breakdown inhibitor comprises particles having a positively charged surface moiety.

14. The electrochemical cell of claim 1, wherein the breakdown inhibitor comprises a semiconductor configured to react with a nucleophilic product of electrolyte breakdown.

15. The electrochemical cell of claim 1, wherein an electrode, an electrolyte, or a separator comprises the breakdown inhibitor.

16-17. (canceled)

18. The electrochemical cell of claim 1, wherein the improved performance is exhibited as an increased operating voltage, an increased cycle life, an increased operating temperature, an increased voltage window, an increased hold time, a decreased leakage current, a decreased impedance rise, or decreased corrosion.

19. The electrochemical cell of claim 1 which is an electrochemical capacitor, a battery, or an electrolytic cell.

20. The electrochemical cell of claim 1 further comprising a non-aqueous electrolyte.

21. (canceled)

22. The electrochemical cell of claim 20 which is an electrochemical capacitor; and
the non-aqueous electrolyte comprises acetonitrile, propionitrile, glutaronitrile, adiponitrile, or methoxyacetonitrile.

23. A method for producing an electrochemical cell, the method comprising:
providing a multilayer structure comprising a cathode and an anode separated by a distance;
providing an electrolyte between the first and second electrodes, wherein the electrolyte contacts the surfaces of the first and second electrodes;
providing a packaging element to contain the multilayer structure and electrolyte;
providing a breakdown inhibitor, which is incorporated into at least one of the layers of the multilayer structure, the electrolyte, or the packaging element; and
subjecting the electrochemical cell to an electric potential that is sufficient to produce breakdown reactions in a control.

24. The method of claim 23, wherein the providing a multilayer structure further comprises providing a separator disposed between the cathode and the anode.

25. (canceled)
